(19) United States
(12) Patent Application Publication
(10) Pub. No.: US 2015/0037765 A1
(43) Pub. Date: Feb. 5, 2015

(54) SYSTEM AND METHOD FOR INTERACTIVE ELECTRONIC LEARNING AND ASSESSMENT

(71) Applicant: Speetra, Inc., Dallas, TX (US)

(72) Inventors: Pawan Jaggi, Plano, TX (US); Abhijeet Sangwan, Allen, TX (US)

(73) Assignee: SPEETRA, INC., Dallas, TX (US)

(21) Appl. No.: 14/450,078

(22) Filed: Aug. 1, 2014

Related U.S. Application Data
(60) Provisional application No. 61/861,861, filed on Aug. 2, 2013.

(51) Int. Cl. G09B 7/02; G09B 19/04; G09B 7/07; H04L 29/08

(52) U.S. Cl. CPC G09B 7/02; H04L 67/10; G09B 19/04; G09B 7/07
USPC 434/169; 434/308; 434/185

(57) ABSTRACT

A system and method for distributing and analyzing a set of tests includes a network, a test system, a manager, and a set of users connected to the network. The method includes the steps of receiving a set of challenges, a set of predetermined responses, and a set of parameters, generating a test message, sending the test message to each user, sending the set of challenges and the set of predetermined answers in response to the test message, receiving a set of audio responses, a set of text responses, a set of video responses, and a set of selected responses from the set of predetermined responses, analyzing the set of audio responses, the set of text responses, the set of video responses, and the set of selected responses, and calculating a set of scores.

### CROSS-REFERENCE TO RELATED APPLICATIONS

This application claims priority to U.S. Provisional Application No. 61/861,861, filed Aug. 2, 2013. The patent application identified above is incorporated herein by reference in its entirety to provide continuity of disclosure.

### FIELD OF THE INVENTION

The present invention relates to training systems and methods. In particular, the present invention relates to a system and method for interactive electronic learning and assessment.

### BACKGROUND OF THE INVENTION

Training has specific goals of improving one's capability, capacity, productivity and performance. In addition to the basic training required for a trade, occupation or profession, there is a need to continue training beyond initial qualifications: to maintain, upgrade, and update skills throughout working life.

With rapid globalization and increased competitiveness, the modern workforce needs to constantly upgrade their language, knowledge, personal and professional work skills. Training can take place on-the-job or off-the-job. However, both types of training require substantial time and money to implement.

On-the-job training takes place in a normal working situation, using the actual tools, equipment, documents or materials that trainees will use when fully trained. On-the-job training has a general reputation as most effective for vocational work. It involves an employee training at the place of work while he or she is performing his or her duties. Usually a professional trainer or sometimes an experienced employee serves as the course instructor using hands-on training often supported by formal classroom training. However, hiring an onsite professional trainer is usually cost prohibitive.

Off-the-job training method takes place away from normal work situations at a site away from the actual work environment. It often utilizes lectures, case studies, role playing and simulation, having the advantage of allowing employees to get away from work and concentrate more thoroughly on the training itself. This type of training has proven more effective in inculcating concepts and ideas. However, the employer loses the productivity of an employee in time and money during this training.

Therefore, there is a need for a system and method that is efficient, effective, and inexpensive to constantly train employees. There is a need for a system and method for interactive electronic learning and assessment.

### SUMMARY

A system and method for distributing and analyzing a set of tests is disclosed. The system includes a network, a test system connected to the network, a manager connected to the network, and a set of users connected to the network. The test system is programmed to store and execute instructions that cause the system to perform the method. The method includes the steps of receiving a set of challenges for the set of tests, a set of predetermined responses, and a set of parameters, generating a test message from the set of parameters, sending the test message to each user of the set of users, sending the set of challenges and the set of predetermined answers in response to the test message, receiving a set of audio responses to the set of challenges, receiving a set of text responses to the set of challenges, receiving a set of video responses to the set of challenges, receiving a set of selected responses from the set of predetermined responses, analyzing the set of audio responses, the set of text responses, the set of video responses, and the set of selected responses, and calculating a set of scores from the set of audio responses, the set of text responses, the set of video responses, and the set of selected responses.

In this manner, the disclosed system and method captures and transforms a human voice and human writing and gesture movements into a set of data that is objectively compared to a correct set of data and objectively scored to evaluate a reading competency, a knowledge base, and a writing competency of the human. Such a system and method is significantly more than the concept itself and a significant improvement over the art.

### BRIEF DESCRIPTION OF THE DRAWINGS

In the detailed description presented below, reference is made to the accompanying drawings.

FIG. 1 is a schematic of a system for learning and assessment of a preferred embodiment.

FIG. 2 is a schematic of system components for a system of a preferred embodiment.

FIG. 3 is a schematic of a system program hierarchy of a preferred embodiment.

FIG. 4 is a screen layout of a pronunciation challenge of a preferred embodiment.

FIG. 5 is a screen layout of an information challenge of a preferred embodiment.

FIG. 6 is a screen layout of a multiple choice challenge of a preferred embodiment.

FIG. 7 is a screen layout of a speech delivery challenge of a preferred embodiment.

FIG. 8 is a screen layout of a writing challenge of a preferred embodiment.

FIG. 9 is a flowchart of a method for distributing and analyzing a set of tests of a preferred embodiment.

FIG. 10 is a flowchart of a method for analyzing pronunciation of a preferred embodiment.

FIG. 11 is a flowchart of a method for analyzing speech delivery of a preferred embodiment.

FIG. 12 is a flowchart of a method for analyzing a set of written responses.

### DETAILED DESCRIPTION

It will be appreciated by those skilled in the art that aspects of the present disclosure may be illustrated and described in any of a number of patentable classes or contexts including any new and useful process or machine or any new and useful improvement. Aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Further, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. The propagated data signal may take any of a variety of forms, including, but not limited to, electro-magnetic, optical, or any suitable combination of them. A computer readable signal medium may be any computer readable medium that is not a computer readable storage medium and that can communicate, propagate, or transport a program for use by or in connection with an instruction execution system, apparatus, or device.

Computer program code for carrying out operations for aspects of the present disclosure may be written in any combination of one or more programming languages, including an object oriented programming language such as Java, C++, C#, .NET, Objective C, Ruby, Python SQL, or other modern and commercially available programming languages.

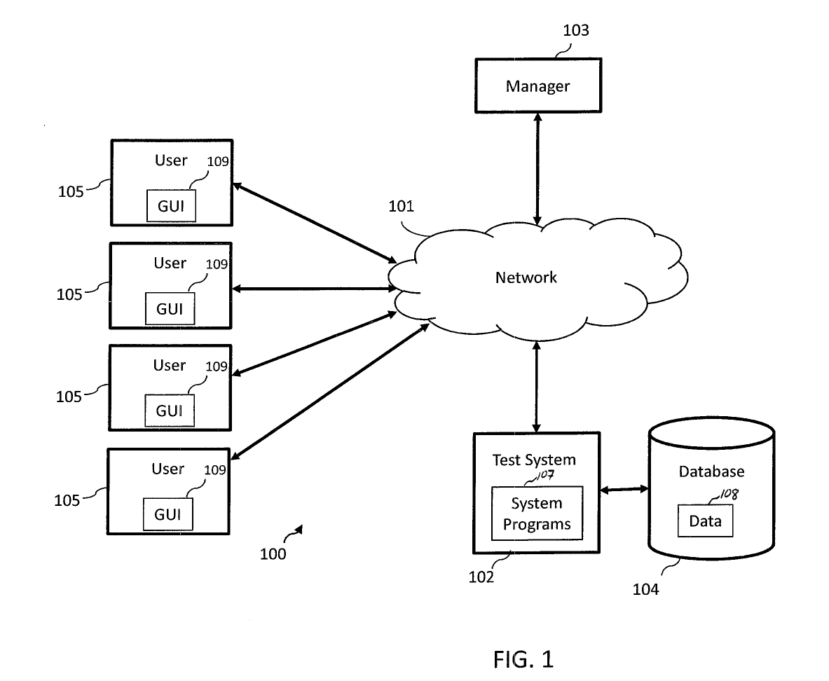

Referring to FIG. 1, system 100 includes network 101, test system 102 connected to network 101, manager 103 connected to network 101, and set of users 105 connected to 101.

In a preferred embodiment, network 101 is the Internet. Test system 102 is further connected to database 104 to communicate with and store relevant data 108 in database 104. Test system 102 includes a set of system programs 107. Users 105 are connected to network 101 by communication devices such as smartphones, PCs, laptops, or tablet computers. Manager 103 is also connected to network 101 through a communication device.

In one embodiment, user 105 communicates through a native application on the communication device. In another embodiment, user 105 communicates through a web browser on the communication device. In another embodiment, user 105 communicates through a stand-alone computer application.

In a preferred embodiment, test system 102 is a server.

In a preferred embodiment, manager 103 is an employer. In this embodiment, user 105 is an employee or potential employee. Other relationships may be employed.

System 100 is accessible on a client-server architecture. Test system 102 uses database 104 to store questions/information as data 108. Test system 102 stores speech and language processing algorithms and performs all the computation. The client side is a light program which presents user 105 with a graphical user interface (GUI) 109. GUI 109 allows the user 105 to interact to record their voice response to the presented questions. Once the user captures their voice response, user 105 sends the file to the test system 102 for analysis, as will be further described below.

System 100 is used to assess and improve communication skills of users 105. The platform automatically measures critical communication skill parameters using speech, text, image, and video processing algorithms. System 100 provides users 105 with a mechanism to capture their audio and video data using a microphone and a camera in or connected to the communication device. Users 105 record their audio/video/text data in response to system prompts. Test system 102 then processes the captured data to measure key communication parameters. Test system 102 then scores these parameters and determines a proficiency level for users 105. Next, user 105 is presented with the analysis and feedback. Test system 102 stores the user audio/video/text data with the analysis and scores and provides design capability where domain specific and generic curriculum is developed.

In one embodiment, system 100 is used as training platform. The system contains algorithms for pronunciation, speaking and writing capability assessment. It is used to train individuals on their pronunciation (or accents), speaking, and writing skills. The open design capability allows individuals and corporations to create their own specialized training programs. System 100 is used for knowledge, specialized skills, and language training. The system supports rich multimedia interfaces in order to create immersive and interactive learning environments. The training program is delivered online and can be accessed through the Internet. Consequently, manager 103 extends their reach by delivering their programs worldwide. Additionally, global corporations can deliver consistent and uniform training programs to their employees worldwide.

In another embodiment, system 100 is used as a hiring platform. Managers 103 design hiring interviews and/or tests. Managers 103 send these tests to potential candidates electronically over the Internet. The potential clients, users 105, then complete the hiring assessment online. Subsequently, reports are generated and delivered to managers 103. In this manner, system 100 makes the hiring process more efficient while reducing costs.

In another embodiment, system 100 is available to third party application developers as an application programming interface (“API”). The API provides access to the automatic speech and text processing algorithms and provides access to user 105 data (audio, video, and text) and meta-data (scores), which are used for business analytics.

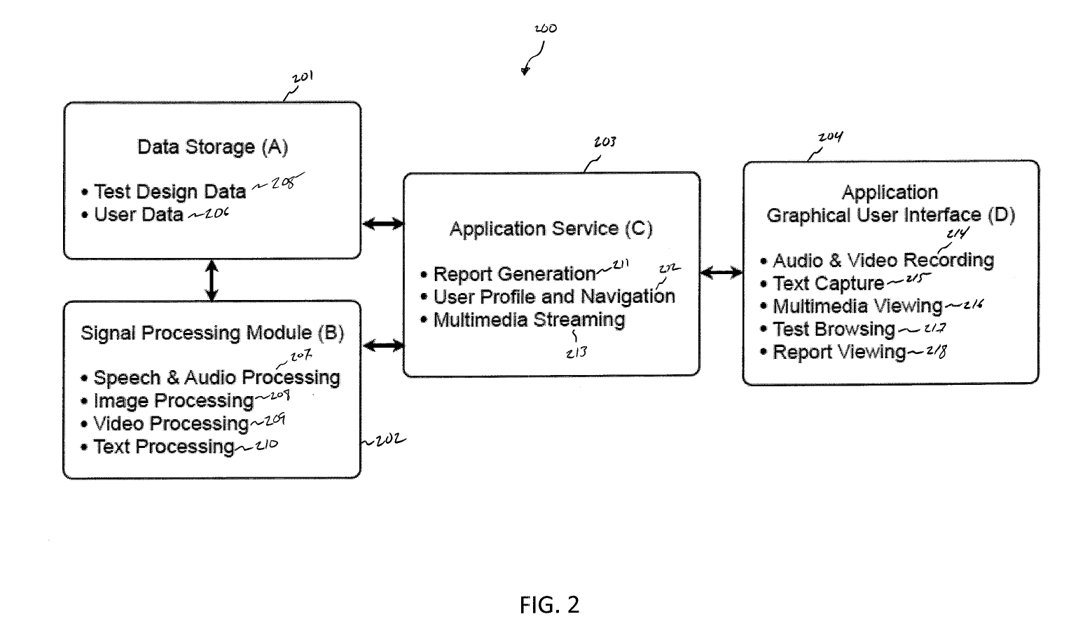

Referring to FIG. 2, system programs 200 includes data storage 201, signal processing module 202 connected to data storage 201, application service 203 connected to data storage 201 and to signal processing module 202, and application GUI 204 connected to application service 203.

Data storage 201 includes test design data 205 and user data 206. Signal processing module 202 includes, speech and audio processing 207, image processing 208, video processing 209, and text processing 210. Application service 203 includes report generation 211, user profile and navigation 212, and multimedia streaming 213. Application GUI 204 includes audio and video recording 214, text capture 215, multimedia viewing 216, test browsing 217, and report viewing 218.

In an online web application embodiment, data storage 201, signal processing module 202, and application service 203 reside on a server of test system 102 or a third party cloud server. In this embodiment, application GUI 204 is a thin client such as a browser.

In a mobile device embodiment, data storage 201, signal processing module 202, and application service 203 reside on a server of test system 102 or a third party cloud server. In this embodiment, application GUI 204 is a native application on a user communication device or a browser.

In a stand-alone computer application embodiment, data storage 201, signal processing module 202, application service 203, and application GUI 204 are all contained in a computer readable medium. The application may be shipped on a server, or deployed on portable storage devices such as USB memory stick, hard disks, and/or CDs/DVDs. Other storage devices and means known in the art may be employed.

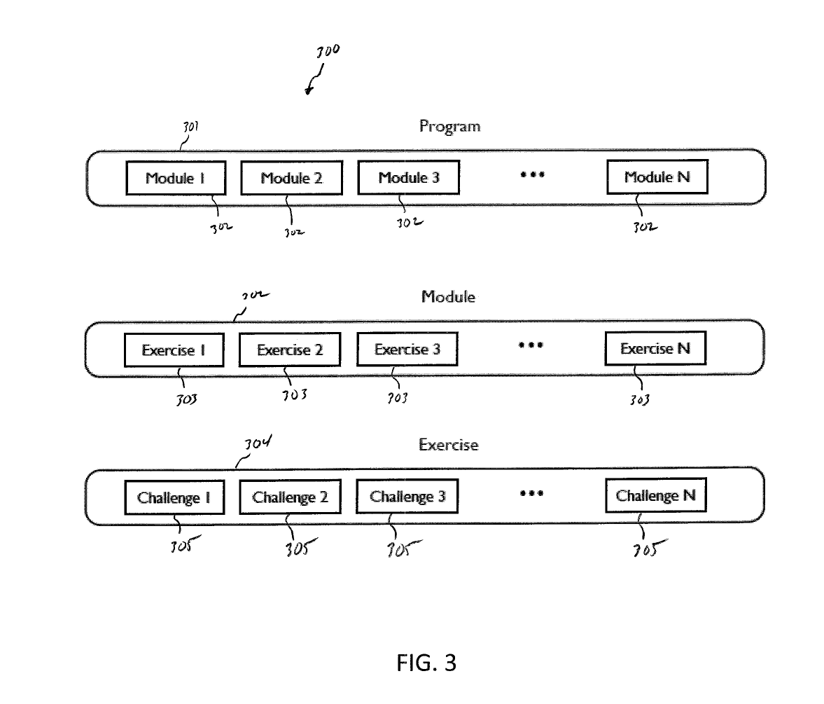

Referring to FIG. 3, test 300 includes a program 301. Each program 301 includes a set of modules 302. Any number of modules may be employed. Each module of the set of modules 302 includes a set of exercises 303. Any number of exercises may be employed. Each exercise of the set of exercises 304 includes a set of challenges 305. Any number of challenges may be employed.

Each test 300 is designed with an intention of measuring proficiency in a specific skill area or examining overall proficiency by evaluating a wide variety of skills. For example, a group of grammar, vocabulary, reading, listening and pronunciation challenges can collectively test a user's language skills. Test 300 is assigned a unique name that identifies the purpose of the test. Test 300 is assigned meta-information such as description which helps users understand what they will be tested on and what they will learn. Test 300 is assigned into categories based on the skill sets they test. For example, vocabulary, grammar, and pronunciation. Test 300 is assigned skill level based on the level of difficulty. For example, beginner, intermediate and advanced skill levels may distinguish tests of varying difficulty. In one embodiment, test 300 is designed to simulate scenarios and/or real-life experiences. For example, a business traveler buying a cup of coffee in a foreign country or any other agent-customer interaction.

The most basic unit of operation between the user and the system includes a challenge-response mechanism. The system prompts the user with a question in a challenge 305, and the user submits their answers or responses. The system scores the user's response based on pre-designed objective criteria.

The system supports multiple types of challenge-response interactions by providing specialized interfaces i.e., screens. Each screen supports a specific type of interaction.

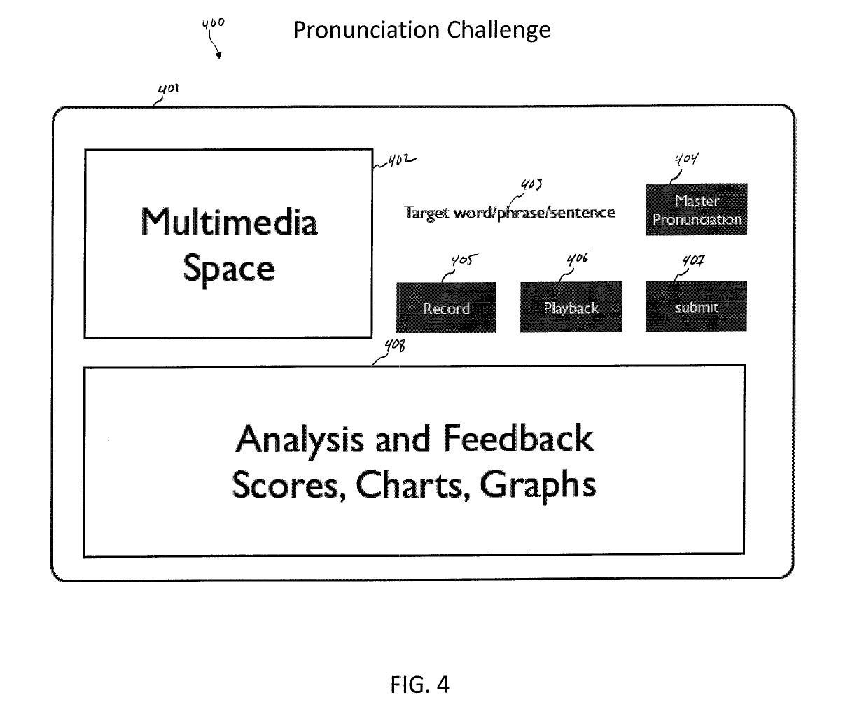

Referring to FIG. 4, screen 400 includes pronunciation challenge 401. Pronunciation challenge 401 includes multimedia space 402, target 403, master pronunciation button 404, record button 405, playback button 406, submit button 407, and analysis and feedback area 408.

In a preferred embodiment, a user is presented with a challenge in the form of a text word, phrase, or sentence in target 403. The user selects the record button 405 and responds by reading the text out loud. The audio response is recorded by the microphone of the user communication device. The record button 405 is selected to end audio recording. Playback button 406 is selected to replay the audio response. Submit button 407 is selected to submit the audio response for scoring. The pronunciation of the response is scored, as will be further described below.

In one embodiment, master pronunciation 404 is provided to the user in a practice mode. The master pronunciation 404 includes of a native speaker speaking the challenge text prompt in multimedia space 402.

In one embodiment, a user is provided with supplementary information which includes tips and other form of guidance in analysis and feedback area 408.

In one embodiment, a user is shown an image and/or videos that contain detailed mouth or articulator movements in multimedia space 402. In another embodiment, the videos and/or images in multimedia space 402 displays other supplementary information such as a word or phrase meaning.

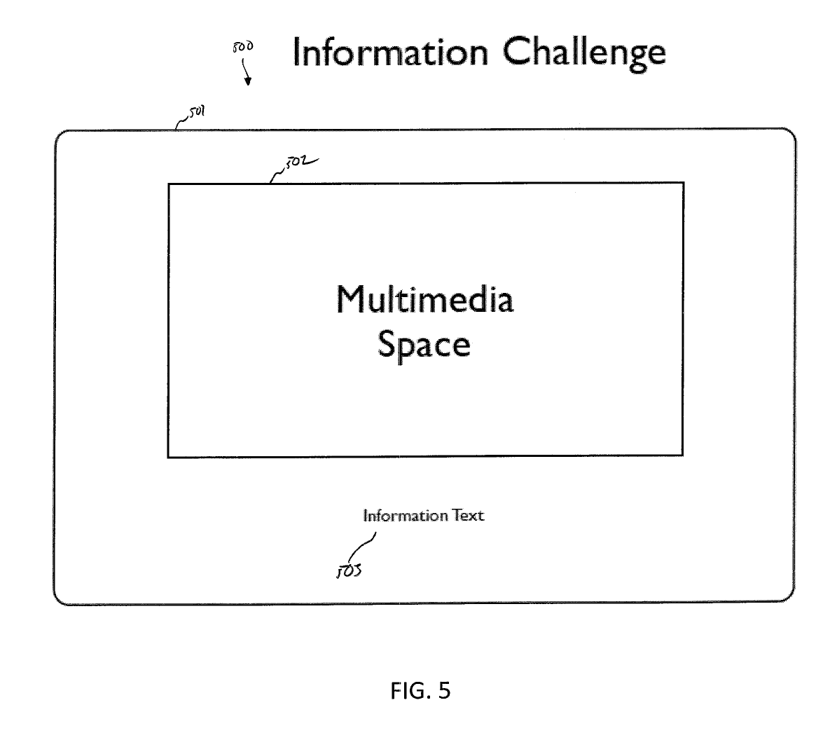

Referring to FIG. 5, screen 500 includes information challenge 501. Information challenge 501 includes multimedia space 502 and information text 503.

In a preferred embodiment, a user is presented with information in the form of text, audio, video, and/or still image in multimedia space 502 and/or in information text 503. The user interacts with information challenge 501 to read, view and/or listen to the information provided and is tested on the information by multiple choice questions, as will be further described below.

In one embodiment, information challenge 501 and/or information text 503 are used to explain a concept in a rich multimedia environment.

In one embodiment, information challenge 501 and/or information text 503 are used to provide a user with factual information. The information can be domain dependent e.g., aircraft parts for a pilot trainee.

In one embodiment, information challenge 501 and/or information text 503 are used to test a user's visual, reading, listening, psychological, and other higher level cognitive skills and is tested by multiple choice questions, as will be further described below.

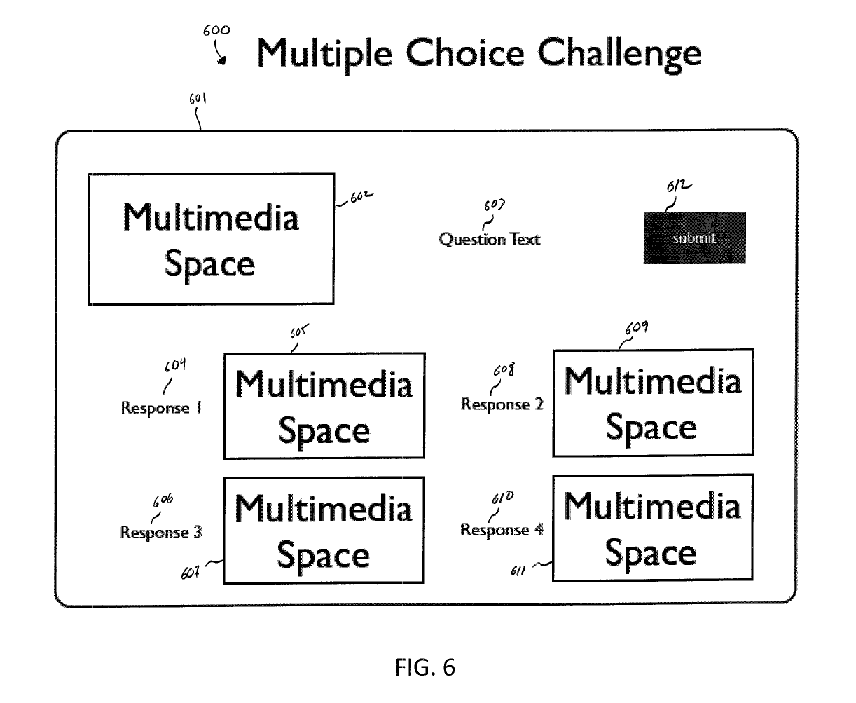

Referring to FIG. 6, screen 600 includes multiple choice challenge 601. Multiple choice challenge 601 includes multimedia space 602, question text 603, responses 604, 606, 608, and 610. Multimedia spaces 605, 607, 609, and 611 correspond to responses 604, 606, 608, and 610, respectively. Multiple choice challenge 601 further includes submit button 612.

In a preferred embodiment, a user is presented with a question challenge in question text 603. The user chooses the correct response from responses 604, 606, 608, and 610. The question challenge can be presented as text, audio, video, image and/or any combination thereof in multimedia space 602. In one embodiment, responses 604, 606, 608, and 610 are presented as text, audio, video, image, and/or any combination thereof in multimedia spaces 605, 607, 609, and 611, respectively.

In one embodiment, a single response or a combination of responses is correct. In a single response case, the user must select the correct response to get credit. In the combination of responses case, the user must select all the correct response to get credit. In one embodiment, selecting some of the correct response may yield the user partial credit.

In one embodiment, multiple choice challenge 601 is used to test a user's knowledge or skill in a wide variety of fields including but not limited to grammar, language, and vocabulary.

In one embodiment, a combination of responses 604, 606, 608, and 610 and multimedia spaces 605, 607, 609, and 611 are used to simulate traditional listening and reading comprehension exercises.

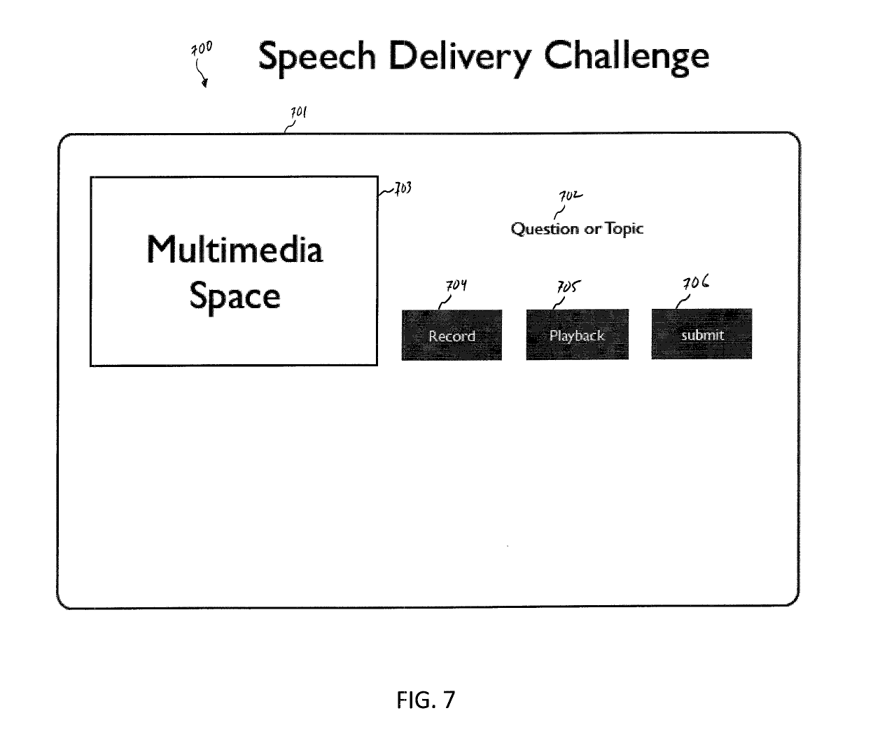

Referring to FIG. 7, screen 700 includes speech delivery challenge 701. Speech delivery challenge 701 includes question/topic 702, multimedia space 703, record button 704, playback button 705, and submit button 706.

In a preferred embodiment, a user is presented with a challenge in the form of a text word, phrase, or sentence at question/topic 702. The user selects the record button 704 and responds by speaking. The audio response is recorded by the microphone of the user communication device. A video response is recorded by the camera of the user communication device. The record button 704 is selected to end audio and video recording. Playback button 705 is selected to replay the audio and video responses. Submit button 706 is selected to submit the user response for scoring.

In a preferred embodiment, the video response is used to record nonverbal bodily movements and reactions, including eye contact.

In one embodiment, multimedia space 703 is used to interview a user with a video chat. In one embodiment, a user uses multimedia space 703 to prepare for an interview. In one embodiment, multimedia space 703 a user uses the record button 704 and playback button 705 to practice their presentation, keynote, talk, toast, and/or sales pitch skills.

In one embodiment, multimedia space 703 is used by a user to practice and improve their reading skills.

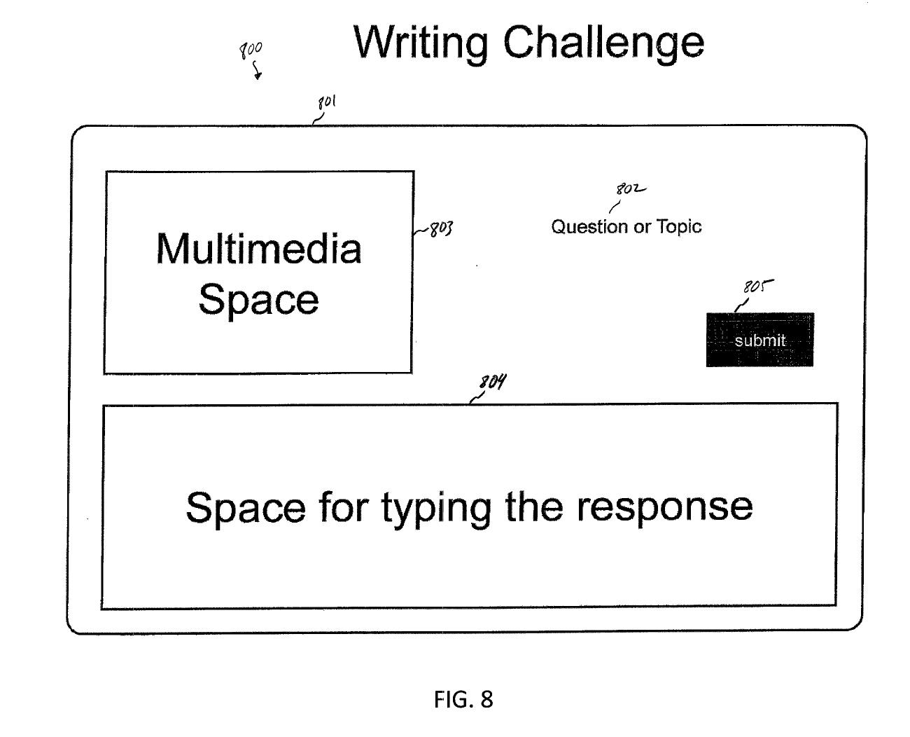

Referring to FIG. 8, screen 800 includes writing challenge 801, question/topic 802, multimedia space 803, written response space 804, and submit button 805.

In a preferred embodiment, a user is presented with a challenge in the form of a text word, phrase, or sentence at question/topic 802 and/or in multimedia space 803. The user types a written response in written response space 804. Submit button 805 is selected to submit the written response for scoring.

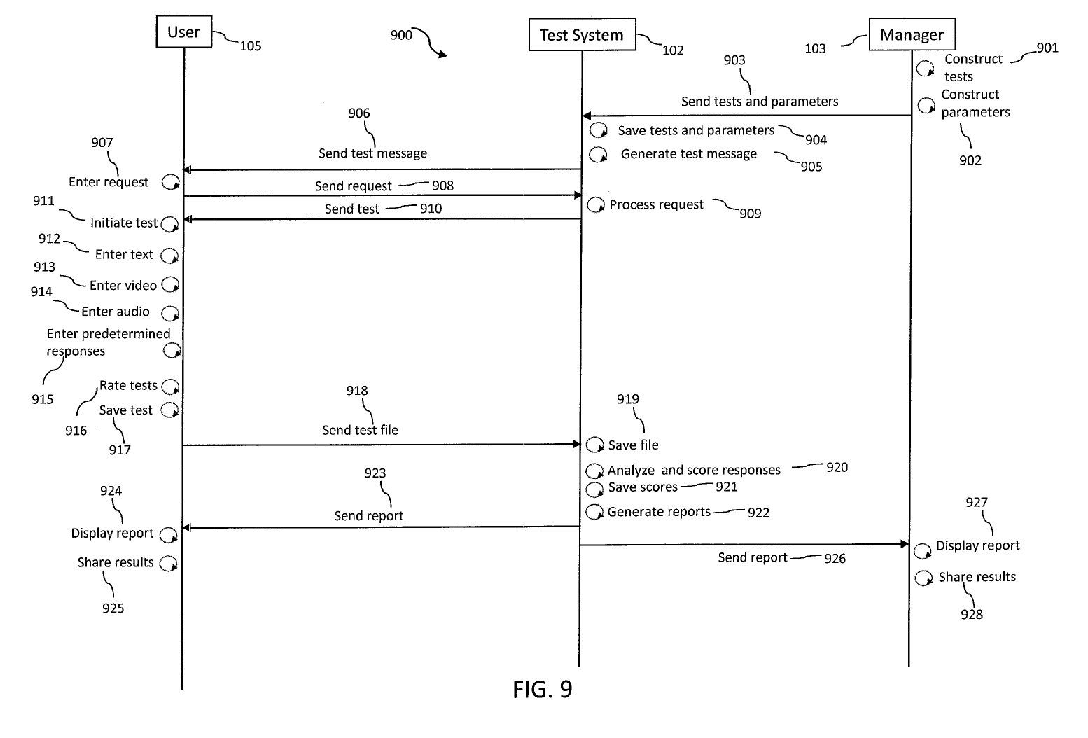

Referring to FIG. 9, method 900 for distributing and analyzing a set of tests will be further described. In the step 901, manager 103 constructs a set of tests. The tests are any number and combination of a pronunciation challenge, an information challenge, a multiple choice challenge, a speech delivery challenge, and a written challenge, as previously described. Manager 103 enters text, audio, and/or video questions or challenges for the set of tests, and a set of predetermined responses for each multiple choice challenge.

In one embodiment, a user is allowed the same permission to create tests as manager 103. The system allows the user to design challenges and tests with the capability of developing curriculum for specific fields or topics. For example, an aviation teacher can develop a pilot training program within the system. The user has the capability of establishing virtual classes within the system. Virtual classes are a collection of tests designed by the user. Other users (referred to as students) can join virtual classes and access the tests.

In one embodiment, hiring assessment tests are designed. In another embodiment, the tests are used as an e-learning platform for teaching. In another embodiment, the system is used as a training tool. In another embodiment, the tests are used as a hiring tool. In another embodiment, the tests are used as a monitoring tool for employees to ensure compliance and quality.

In step 902, manager 103 enters a set of parameters for the set of tests. In a preferred embodiment, the set of parameters includes a set of score criteria for each of the information challenge, the multiple choice challenge, the speech delivery challenge, the written challenge and a set of correct answers to the multiple choice challenge. The set of parameters further includes a test message, a set of user rating questions, and a set of report criteria for a feedback report and a user report. The set of report criteria includes a report frequency, layout, delivery method, any share permissions for user 105, and a set of score statistics to be calculated and included in the report. The set of score statistics includes a set of desired score ranges overall and for each skill. The set of score statistics further include a set of definitions for defining further recommended actions based on the set of desired score ranges, such as needs training or terminate employee. For example, the score ranges determine a training interval and employee recommendations. In this example, the set of desired score ranges are divided by correct score percentages of 0 to 25%, 25% to 50%, 50% to 75%, and 75% to 100%. The set of definitions define that any score below 50% returns a recommendation for more training and any score below 25% returns a recommendation for termination of the employee. Any range and any recommendation related to the range may be employed. Different ranges may be employed for overall scores and scores for each skill and may vary with respect to each skill. The set of parameters further includes a set of keywords and phrases.

In step 903, the set of tests and the set of parameters are sent to test system 102. In step 904, the set of tests and the set of parameters are saved into a database. In step 905, the test message is generated. In a preferred embodiment, the test message is a link in an email or text message. In another embodiment, a ticket number may be generated as the test message for single or multiple use for a test. Using the ticket number, any user is able to take the test. In step 906, the test message is sent to user 105. In step 907, user 105 enters a test request by clicking on the link and entering a set of user demographic information and login information. In step 908, the request is sent to test system 102. Once logged in, a user browses through the tests available within the system. The tests can be sorted, filtered, and searched based on one or multiple demographic information.

In step 909, the request is processed by test system 102 and the requested test is retrieved from the database. In step 910, the test is sent to user 105. In step 911, the set of tests is initiated. In a preferred embodiment, the set of tests works in two modes: evaluation and practice. In evaluation mode, the user's response is scored but the scores are not shown to the user at the end, as will be further described below. In practice mode, the user's response is scored and the scores are immediately presented to the user as feedback.

In a preferred embodiment, a program has a specific regimen as it takes users through a pre-determined set of tests in a pre-determined order. In this embodiment, the program is designed for a specific objective and the user is made aware of the objective prior to starting a program. For example, sales training, pronunciation training, enhancing vocabulary, language learning are used as objectives. Once a user begins a program, the system takes the user through a series of tests which the user can take at their own time and pace. The test shows the entire program to the user along with the material they have finished and the material they have yet to complete. Any material that the user has taken already is also available for review.

In step 912, a set of written responses are entered by user 105. In step 913, a set of video responses is entered by user 105. In step 914, a set of audio responses is entered by user 105. In step 915, user 105 selects a subset of the set of predetermined responses as responses to a set of multiple choice challenges. In step 916, user 105 rates the set of tests by responding to the set of rating questions. In step 917, the set of tests, the set of written responses, the set of video responses, the set of audio responses, the selected predetermined responses, and the test ratings are saved in a test file. In step 918, the test file is sent to test system 102. In step 919, the test file is saved. In step 920, the set of written responses, the set of video responses, and the set of audio responses are analyzed and scored, as will be further described below. In this step, the selected predetermined responses are compared to the set of correct answers and scored for correct responses.

In step 921, the scores are saved. In step 922, a set of reports is generated for review of the set of tests and responses by user 105 and manager 103 according to the set of parameters. The set of reports includes the set of scores and any incorrect responses.

In one embodiment, the set of statistics is generated for the manager report.

In step 923, user 105 is sent a user report. The user report includes the user's responses in an audio, video or text file for each challenge, the corresponding score and any feedback, suggestions, and/or tips to improve. In one embodiment, the user report compares the user to experts or other users or a group of users. Such comparison offers the user a chance to understand their skill level with respect to another individual or group.

In step 924, the user report is displayed to user 105. In one embodiment, a printing operation is provided for the user to obtain a physical copy of the report. In step 925, user 105 shares the results, if granted permission, via email or through social media. In step 926, the manager report is sent to manager 103. In one embodiment, the manager report compares the user to experts or other users or a group of users. In another embodiment, manager 103 assigns a test to a user in order to assess their skill level. Here, manager 103 sees the report but the user may not see their report. This operation may be used in hiring where the user is a potential employee. In step 927, the manager report is displayed for review by manager 103. In one embodiment, a printing operation is provided for manager 103 to obtain a physical copy of the reports. In one embodiment, the manager report is a set of dashboards deployed via a third party cloud server. The set of dashboards include the scores, responses, tests, and the set of score statistics, as previously described.

In step 928, manager 103 shares the result in the manager report via email or social media. In one embodiment, the manager report is exported to a set of reports in a spreadsheet file. The spreadsheet file contains user scores and user demographic information. The reports are exported over any provided timeline (beginning and ending dates). The report export functionality is also available through the software API. In the case of employees, the collection of user scores provides a comprehensive skill-landscape to corporations. This information is used to plan informed training schedules and make training program decisions. In the case of potential employees, the set of user scores and statistics is used to determine entry-level score cutoffs. When analyzing the scores with employee cutoffs, the analysis reveals important information about skill availability across hiring geographies, and other relevant resources. In one embodiment, the set of scores and statistics are used to benchmark and index the communication skills (reading, listening, speaking and writing) of all or some employees of an organization. The scores are determined from a single test or a series of tests. The tests and scores may assess any desirable skill areas. The results of the tests, including the set of score statistics, are used to drive a number of key business decisions by the manager including promotions, identifying skill gaps, designing custom learning and training programs, terminating poor performing users, and rewarding and recognizing high performing users. When used for hiring, the scores and skill specific scores (reading, listening, writing, speaking and others) are indexed against universities, colleges, and cities. Such information is used to plan future recruitment drives and identify talent potential across the hiring map. When used for employees, the test scores are used to index employees, departments, and geographies for skill potential. By delivering periodic tests, the skill potential of individuals and organization are tracked over time. Outcome of learning or other interventions are measured in a systematic manner.

As a result, the disclosed system and method captures and transforms a human voice and human writing and gesture movements into a set of data that is objectively compared to a correct set of data and objectively scored to evaluate a reading competency, a knowledge base, and a writing competency of the human, which significantly enhances the productivity and training of a workforce.

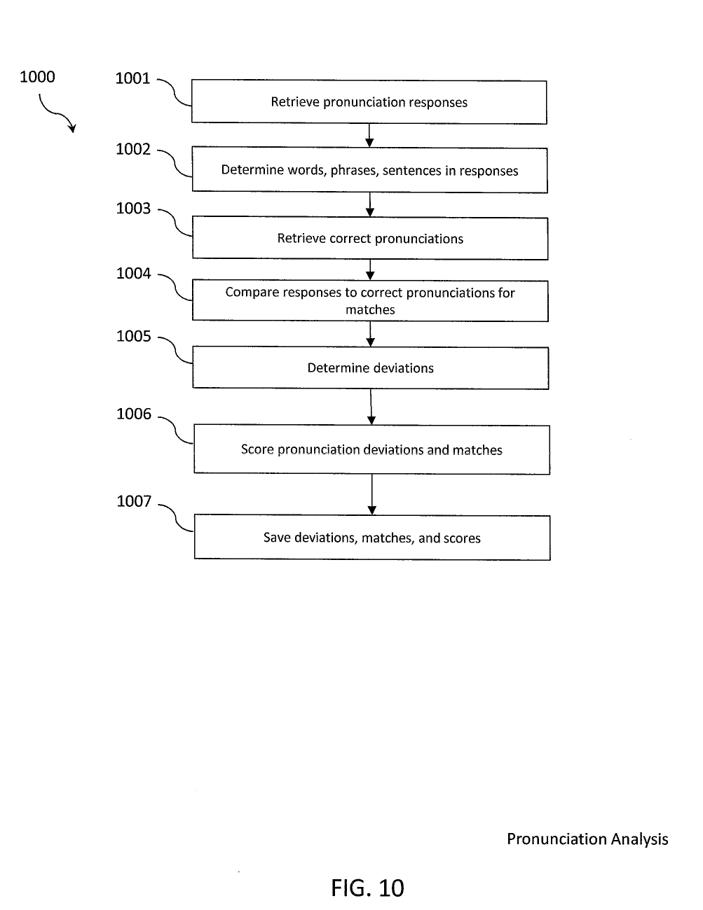

Referring to FIG. 10, method 1000 for analyzing and scoring a pronunciation response will be described. In step 1001, a set of pronunciation responses is retrieved from a test file. In step 1002, a set of words, phrases, and sentences are determined from the set of pronunciation responses by speech recognition and measuring the pauses in between the words, phrases, sentences. The set of pronunciation responses are compared to a set of common phrases retrieved from the database for any matches. Each of the set of common phrases is an audio fingerprint. Each audio fingerprint is a condensed acoustic summary that is deterministically generated from an audio signal of the correct word, phrase, or sentence. In step 1003, a set of correct pronunciations is retrieved from the database. Each of the set of correct pronunciations is an audio fingerprint. In one embodiment, the set of correct pronunciations is from a native speaker.

In step 1004, the set of pronunciation responses is compared to the set of correct responses for matches. In this step, the set of pronunciations responses is scanned and compared to the set of correct pronunciations for any matches. In step 1005, a set of deviations is determined from any of the set of pronunciations that do not match any of the set of correct responses.

In step 1006, the set of deviations and the set of matches are scored. In one embodiment, each match receives one point and each deviation deducts one point. The points are summed for an overall pronunciation score. The points are assigned and summed per word, phrase, sentence, and phoneme. In one embodiment, an alignment technique is employed to detect insertions, deletions, and substitutions in non-native pronunciation. For example, finite state transducers (FSTs) are programmed on non-native pronunciation to automatically deliver such information. The relative importance of different phonemes is automatically scanned and saved from a set of written materials which also have assigned scores for pronunciations. For example, a maximum entropy (ME) based technique may be utilized to automatically learn the relative importance of different phonemes with respect to its impact of final pronunciation score. Word and sentence level scores for pronunciation are calculated by aggregating phoneme level scores. To increase the reliability of scoring pronunciation of a certain phoneme, multiple words containing the phoneme may be utilized within the same test. In a preferred embodiment, an overall pronunciation score is calculated. In one embodiment, an individual phoneme score is calculated. In one embodiment, a sentence score is calculated. In one embodiment, a word score is calculated.

In step 1007, all matches, the set of deviations, and the set of scores are saved.

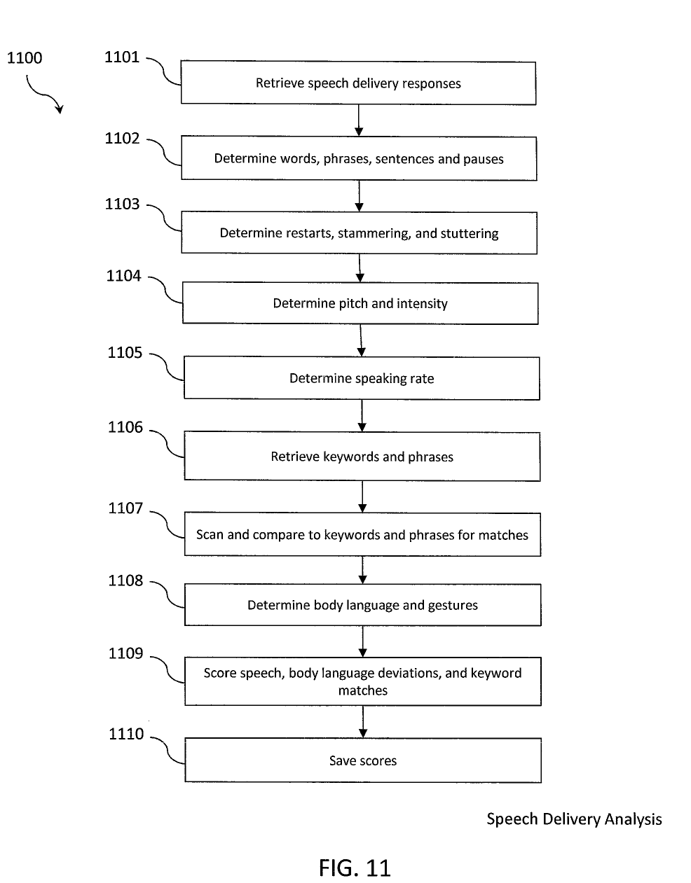

Referring to FIG. 11, method 1100 for analyzing and scoring a speech delivery response will be described. In step 1101, a set of speech delivery responses is retrieved from a database. In step 1102, a set of words, phrases, and sentences and pauses are determined from the set of speech delivery responses by speech recognition and measuring the pauses in between the words, phrases, sentences. The set of speech delivery responses are compared to a set of common phrases retrieved from the database. Each of the set of common phrases is an audio fingerprint. Spontaneous speech consists of alternating speech and pause intervals. The duration of these speech and pause intervals is measured, and its probability distribution is estimated. From this distribution, a number of statistical parameters including mean and standard deviation are estimated. These parameters are referred to as a set of duration parameters.

In step 1103, any restarts, stammering, and stuttering in the set of speech delivery responses are determined. In this step, each of the set of speech delivery responses is scanned for any repeated sounds within a predetermined time to detect any restarts, stammering, and stuttering. The set of repeated sounds are counted.

In step 1104, a pitch and an intensity of the set of speech delivery responses are determined. The pitch and the intensity (amplitude) are measured on a frame-by-frame basis from the set of speech delivery responses. Intensity is measured directly from the set of speech delivery responses. Pitch is measured from the audio file for a frequency range. From these measurements, a probability distribution is estimated and a number of statistical parameters including mean and standard deviation are estimated. These parameters are referred to as a set of modulation parameters. The set of modulation parameters are displayed to the user as an absolute number in suitable units such as Hertz for tone and decibels for intensity. In another embodiment, discrete labels are used such as loud, soft or optimal for intensity, and flat, optimal, or over-modulated for tone when compared to a set of predetermined ranges for the discrete labels. Any number of discrete labels may be used. In another embodiment, pitch can be estimated using pitch estimation algorithms based on auto-correlation, cepstrum, or other known techniques.

In step 1105, a speaking rate for each of the set of speech delivery responses is determined. The speaking rate is measured in words per unit-time, phonemes per unit-time, or syllables per unit-time. Any signal processing based techniques may be used to measure the speaking rate. The speaking rate is displayed to the user as an absolute number in suitable units such as words per minute. In an alternative embodiment, the speaking rate is reported as a discrete label such as slow, optimal or fast after being compared to a set of predetermined speaking rate ranges. Any number of discrete labels may be used.

In step 1106, a set of keywords and phrases is retrieved from the database. In a preferred embodiment, each of the set of keywords and phrases is an audio fingerprint. In step 1107, the set of speech delivery responses is scanned and compared to the set of keywords and phrases for any matches. For example, the set of keywords and phrases include words related to emotions including empathy such as “I am sorry” and “I understand”. In another example, if the user is expected to greet first before speaking, the set of keywords and phrases include greetings such as “Hello” and “Good Morning”. Any type of keywords and phrases may be employed.

In step 1108, the set of speech delivery responses is scanned for any sudden bodily movements and body language including eye contact. The system measures a distance and a frequency of body part movement, such as hand movement, to estimate a user's body language. For example, frequent hand movement indicates excitement. The system performs eye tracking to estimate the user's focal point and compares the focal point to a predetermined center for a deviation amount. Based on the focal point, the duration of a user's eye-contact is estimated.

In step 1109, the set of speech delivery responses, including body language deviations, and keyword matches are scored. In one embodiment, the absence and presence of certain keywords are used to score speaking ability. For example, a customer care agent may be required to use words such as “Thank you”, “Please” while speaking. In this embodiment, a point is rewarded for every keyword match and deducted for every keyword absence or non-match. The body language deviations and frequencies are averaged and compared to a set of predetermined deviation and frequency scores.

The set of duration parameters are compared to a set of predetermined parameters and the difference is calculated for a set of duration scores. The set of duration scores is displayed to the user as absolute numbers in a suitable time-unit such as seconds. The set of modulation parameters are compared to a set of predetermined modulation parameters and the difference is calculated for a set of modulation scores. The set of modulation scores and the set of duration scores are averaged. In another embodiment, the set of duration scores are classified with discrete labels that the speech and pause duration was short, optimum or long when compared to predetermined duration ranges. Any number of discrete labels may be used. Speaking rate, repeated sounds count, the set of modulation scores, and the set of duration scores are reported. The averages of these scores estimate the quality, intelligibility, and effectiveness of speech delivery. In step 1110, the scores are saved.

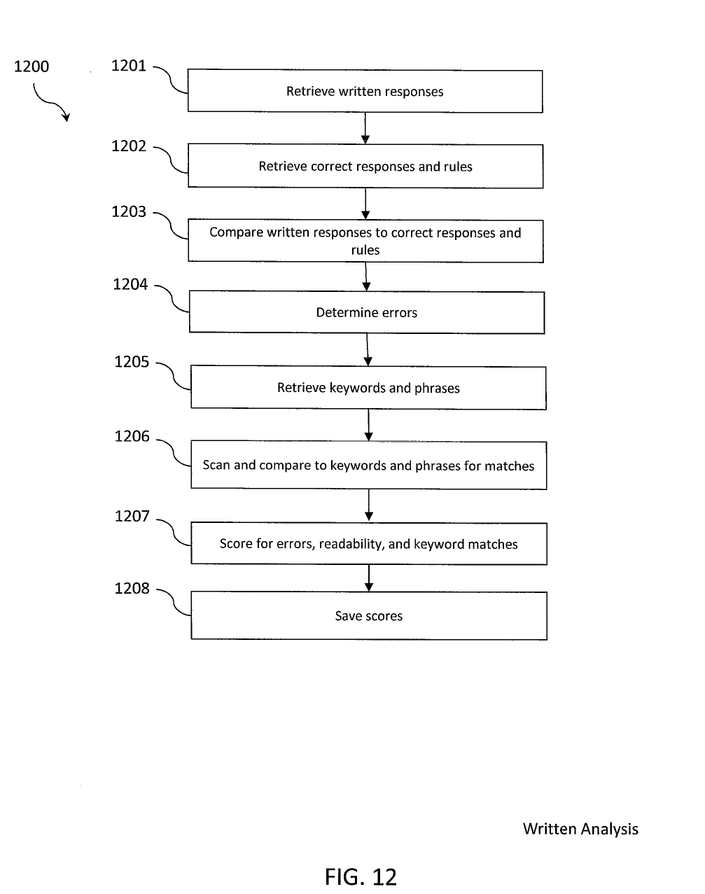

Referring to FIG. 12, method 1200 for analyzing and scoring a set of written responses will be further described. In step 1201, the set of written responses is retrieved from the database. In step 1202, a set of correct written responses and a set of rules are retrieved from the database. In a preferred embodiment, the set of rules includes capitalization rules such as beginning a new sentence with an uppercase alphabet, grammar rules such as the use of correct verb tense, articles, and prepositions, and punctuation rules. Other grammar rules may be employed.

In step 1203, the set of written responses is compared to the set of correct written responses and the set of rules for any matches. In step 1204, any non-matches are counted as an error. An error is detected if a rule is violated.

In step 1205, a set of keywords and phrases are retrieved from the database. In step 1206, the set of written responses is scanned and compared with the set of keywords and phrases for any matches. In step 1207, the set of errors and the set of keyword matches are scored for readability. A writing ability is measured by comparing the syntax of the written material such as grammar, punctuation, spellings, and capitalization. The amount of rules errors and spelling errors are summed for an overall writing score for readability. The position of the errors, the reason for the error, and the suggestion correction are saved as feedback.

In one embodiment, the absence and presence of certain keywords are used to score writing ability. In this embodiment, a point is rewarded for every keyword match and deducted for every keyword absence or non-match. In step 1208, the scores are saved.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. In a system for distributing and analyzing a set of tests comprising a network, a test system connected to the network, a manager connected to the network, and a set of users connected to the network, the test system programmed to store and execute instructions that cause the system to perform a method comprising the steps of:
receiving a set of challenges, a set of predetermined responses, and a set of parameters;
generating a test message from the set of parameters;
sending the test message to each user of the set of users;
sending the set of challenges and the set of predetermined responses in response to the test message;
receiving a set of audio responses to the set of challenges;
receiving a set of text responses to the set of challenges;
receiving a set of video responses to the set of challenges;
receiving a set of selected responses from the set of predetermined responses;
analyzing the set of audio responses, the set of text responses, the set of video responses, and the set of selected responses; and,
calculating a set of scores from the set of audio responses, the set of text responses, the set of video responses, and the set of selected responses.

2. The method of claim 1, further comprising the step of generating a set of reports from the set of scores.

3. The method of claim 1, wherein the step of analyzing further comprises the steps of:
retrieving a set of pronunciation responses from the set of audio responses;
determining a set of words, phrases, and sentences from the set of pronunciation responses;
retrieving a set of correct pronunciations;
comparing the set of words, phrases, and sentences to the set of correct pronunciations to generate a set of pronunciation matches;
determining a set of pronunciation deviations; and,
scoring the set of pronunciation matches and the set of pronunciation deviations.

4. The method of claim 1, wherein the step of analyzing further comprises the steps of:
retrieving a set of speech delivery responses;
determining a set of repeated sounds from the set of speech delivery responses;
determining a pitch and an intensity from the set of speech delivery responses;
determining a speaking rate from the set of speech delivery responses;
retrieving a set of speech delivery keywords and phrases;
comparing the set of speech delivery responses to the set of speech delivery keywords and phrases to generate a set of speech delivery matches;
determining a set of body language deviations and a set of gestures; and,
scoring the set of speech delivery matches, the set of body language deviations, the set of gestures, the set of repeated sounds, the pitch, the intensity, and the speaking rate.

5. The method of claim 1, wherein the step of analyzing further comprises the steps of:
retrieving a set of written responses;
retrieving a set of correct written responses and a set of rules;
comparing the set of written responses to the set of correct written responses and the set of rules to generate a set of written matches;
determining a set of written errors from the set of written matches;
retrieving a set of written keywords and phrases;
comparing the set of written responses to the set of written keywords and phrases to generate a set of written keyword matches; and,
scoring the set of written errors, the set of written matches, and the set of written keyword matches.

6. The method of claim 1, wherein the step of analyzing further comprises the steps of:
retrieving a set of correct multiple choice answers;
comparing the set of selected responses to the set of correct multiple choice answers to generate a set of multiple choice matches; and,
scoring the set of multiple choice matches.

7. In a system for distributing and analyzing a set of tests comprising a network, a test system connected to the network, a manager connected to the network, and a set of users connected to the network, the test system programmed to store and execute instructions that cause the system to perform a method comprising the steps of:
receiving a set of pronunciation challenges, a set of informational challenges, a set of multiple choice challenges, a set of speech delivery challenges, a set of writing challenges, a set of predetermined responses, and a set of parameters;
generating a test message from the set of parameters;
sending the test message to each user of the set of users;
sending the set of pronunciation challenges, the set of informational challenges, the set of multiple choice challenges, the set of speech delivery challenges, the set of writing challenges, and the set of predetermined responses, in response to the test message;
receiving a set of pronunciation responses to the set of pronunciation challenges;
receiving a set of written responses to the set of writing challenges;
receiving a set of speech delivery responses to the set of speech delivery challenges;
receiving a set of selected responses from the set of predetermined responses;
analyzing the set of pronunciation responses, the set of written responses, the set of speech delivery responses, and the set of selected responses; and,
calculating a set of scores from the set of pronunciation responses, the set of written responses, the set of speech delivery responses, and the set of selected responses.

8. The method of claim 7, further comprising the step of generating a set of reports from the set of scores.

9. The method of claim 7, wherein the step of analyzing further comprises the steps of:
determining a set of words, phrases, and sentences from the set of pronunciation responses;
retrieving a set of correct pronunciations;
comparing the set of words, phrases, and sentences to the set of correct pronunciations to generate a set of pronunciation matches;
determining a set of pronunciation deviations; and,
scoring the set of pronunciation matches and the set of pronunciation deviations.

10. The method of claim 7, wherein the step of analyzing further comprises the steps of:
determining a set of repeated sounds from the set of speech delivery responses;
determining a pitch and an intensity from the set of speech delivery responses;
determining a speaking rate from the set of speech delivery responses;
retrieving a set of speech delivery keywords and phrases;
comparing the set of speech delivery responses to the set of speech delivery keywords and phrases to generate a set of speech delivery matches;
determining a set of body language deviations and a set of gestures; and,
scoring the set of speech delivery matches, the set of body language deviations, the set of gestures, the set of repeated sounds, the pitch, the intensity, and the speaking rate.

11. The method of claim 7, wherein the step of analyzing further comprises the steps of:
retrieving a set of correct written responses and a set of rules;
comparing the set of written responses to the set of correct written responses and the set of rules to generate a set of written matches;
determining a set of written errors from the set of written matches;
retrieving a set of written keywords and phrases;
comparing the set of written responses to the set of written keywords and phrases to generate a set of written keyword matches; and,
scoring the set of written errors, the set of written matches, and the set of written keyword matches.

12. The method of claim 7, wherein the step of analyzing further comprises the steps of:
retrieving a set of correct multiple choice answers;
comparing the set of selected responses to the set of correct multiple choice answers to generate a set of multiple choice matches; and,
scoring the set of multiple choice matches.

13. A system for distributing and analyzing a set of tests comprising:
a network;
a test system connected to the network;
a manager connected to the network;
a set of users connected to the network;
the test system programmed carry out the steps of:
receiving a set of challenges, a set of predetermined responses, and a set of parameters;
generating a test message from the set of parameters;
sending the test message to each user of the set of users;
sending the set of challenges and the set of predetermined responses in response to the test message;
receiving a set of audio responses to the set of challenges;
receiving a set of text responses to the set of challenges;
receiving a set of video responses to the set of challenges;
receiving a set of selected responses from the set of predetermined responses;
analyzing the set of audio responses, the set of text responses, the set of video responses, and the set of selected responses; and,
calculating a set of scores from the set of audio responses, the set of text responses, the set of video responses, and the set of selected responses.

14. The system of claim 13, wherein the test system is further programmed to carry out the step of generating a set of reports from the set of scores.

15. The system of claim 13, wherein the test system is further programmed to carry out the steps of:
retrieving a set of pronunciation responses from the set of audio responses;
determining a set of words, phrases, and sentences from the set of pronunciation responses;
retrieving a set of correct pronunciations;
comparing the set of words, phrases, and sentences to the set of correct pronunciations to generate a set of pronunciation matches;
determining a set of pronunciation deviations; and,
scoring the set of pronunciation matches and the set of pronunciation deviations.

16. The system of claim 13, wherein the test system is further programmed to carry out the steps of:
retrieving a set of speech delivery responses;
determining a set of repeated sounds from the set of speech delivery responses;
determining a pitch and an intensity from the set of speech delivery responses;
determining a speaking rate from the set of speech delivery responses;
retrieving a set of speech delivery keywords and phrases;
comparing the set of speech delivery responses to the set of speech delivery keywords and phrases to generate a set of speech delivery matches;
determining a set of body language deviations and a set of gestures; and,
scoring the set of speech delivery matches, the set of body language deviations, the set of gestures, the set of repeated sounds, the pitch, the intensity, and the speaking rate.

17. The system of claim 13, wherein the test system is further programmed to carry out the steps of:
retrieving a set of written responses;
retrieving a set of correct written responses and a set of rules;
comparing the set of written responses to the set of correct written responses and the set of rules to generate a set of written matches;
determining a set of written errors from the set of written matches;
retrieving a set of written keywords and phrases;
comparing the set of written responses to the set of written keywords and phrases to generate a set of written keyword matches; and,
scoring the set of written errors, the set of written matches, and the set of written keyword matches.

18. The system of claim 13, wherein the test system is further programmed to carry out the steps of:
retrieving a set of correct multiple choice answers;
comparing the set of selected responses to the set of correct multiple choice answers to generate a set of multiple choice matches; and,
scoring the set of multiple choice matches.

19. The system of claim 13, wherein the test system is further programmed to carry out the steps of:
generating a set of score statistics from the set of scores;
displaying the set of score statistics in a dashboard;
wherein the set of score statistics further comprise a set of training intervention ranges, a set of employee recommendations, and a set of skill gap ranges.
